(19) United States
(12) Patent Application Publication
(10) Pub. No.: US 2013/0166399 A1
(43) Pub. Date: Jun. 27, 2013

(54) METHOD FOR TRANSFERRING RICH COUPONING AND ADVERTISING CONTENT AT THE POINT OF SALE INITIATED BY A SINGLE NFC TAP

(71) Applicant: Mohamed AWAD, Ladera Ranch, CA (US)

(72) Inventor: Mohamed AWAD, Ladera Ranch, CA (US)

(73) Assignee: BROADCOM CORPORATION, Irvine, CA (US)

(21) Appl. No.: 13/334,655

(22) Filed: Dec. 22, 2011

(51) Int. Cl. H04B 5/00; G06Q 30/02; G06Q 20/20

(52) U.S. Cl. 705/16; 455/41.1; 705/14.64; 705/14.1

(57) ABSTRACT

A method for wirelessly transferring information between a mobile device and a retailer is disclosed. The retailer receives communication protocol information from a mobile device via a NFC communication link between the retailer and the mobile device. The retailer determines a best fit match between communication protocols available to the retailer and available communication protocols received from the mobile device other than the NFC communication link. The retailer sends content information to the mobile device using the best fit match determined by the retailer.

### BACKGROUND

1. Field of the Disclosure

The present disclosure relates generally to near field communications.

2. Background Art

Near field communication, or NFC, is a set of short-range wireless technologies, typically requiring a distance of 4 cm or less. NFC generally operates at 13.56 MHz and at rates ranging from about 106 kbit/s to 848 kbit/s. NFC generally involves a reader (or initiator) and a tag (or target); the reader actively generates an RF field that can power a passive tag. This enables NFC tags to be configured so as to have very simple form factors such as tags, stickers, key fobs, or cards that do not require batteries. NFC peer-to-peer communication is of course possible, where both devices are powered. Devices that contain both reader and tag capabilities are often called controllers.

Generally, NFC requires that NFC devices be present within a relatively close proximity to each other so that their corresponding magnetic fields can exchange information. Typically, a first NFC device transmits or generates a magnetic field modulated with the information, such as the credit information or the ticket fare information. This magnetic field inductively couples onto a second NFC device that is proximate to the first NFC device. The second NFC device may respond to the first NFC device by transmitting or generating its own modulated magnetic field and inductively coupling this magnetic field to the first NFC device.

Near Field Communications is currently being added to cell phones and other portable or mobile devices for facilitating secure financial transactions. These same mobile devices often contain multiple mechanisms or protocols for transmitting and/or receiving information, such as, but not limited to, cellular communications, Internet communications, WiFi communications, Bluetooth or Bluetooth Low Energy (BLE) communications, SMS text, etc.

Retailers and/or credit card companies would like to be able to communicate directly with a user's mobile device either when the user pays for a purchase with the mobile device or shortly thereafter to present advertising content of the retailer to the user. It would be useful to be able provide advertising content to the user without requiring the user to maintain a NFC communication between the mobile device and a Point of Sale (POS) terminal for more than just a “tap” time.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 shows a block diagram of an NFC environment.

FIG. 2 is a block diagram of an embodiment incorporating features of the disclosure.

FIG. 3 is a flowchart of the process for providing communication protocol information from a mobile device to a retailer.

FIG. 4 is a flowchart of the process for providing advertising content from a POS terminal (or similar device) to a mobile device in accordance with an aspect of this disclosure.

The present disclosure will be described with reference to the accompanying drawings. Generally, the drawing in which an element first appears is typically indicated by the leftmost digit(s) in the corresponding reference number.

### DETAILED DESCRIPTION

The following Detailed Description refers to the accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments of the disclosure may be implemented in hardware, firmware, software, or any combination thereof. The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the description of the present disclosure is to be described in terms of NFC, those skilled in the relevant art(s) will recognize that the present disclosure may be applicable to other communications that use the near field and/or the far field without departing from the spirit and scope of the present disclosure. For example, although the present disclosure is to be described using NFC capable communication devices, those skilled in the relevant art(s) will recognize that functions of these NFC capable communication devices may be applicable to other communications devices that use the near field and/or the far field without departing from the spirit and scope of the present disclosure.

Throughout this disclosure, reference will be made to mobile devices. The term “mobile device” as used herein is intended to encompass any type of portable device, including, but not limited to, mobile phones, tablet computers, laptop or notebook computers, or any other portable electronic device that has communications capability and is typically, but not necessarily, capable of easily being carried by a user. In addition, reference will also be made to a “retailer.” The term “retailer” as used herein is intended to encompass a single stand-alone retail establishment, or a chain of retail establishments interconnected with each other and/or to a central location electronically, such as, but not limited to, such retail establishments as Walmart®, Macy's®, Safeway®, etc. The term “retailer” as used herein is also intended to encompass financial institutions, such as credit card companies and similar financial credit companies, such as, but not limited to, Visa®, Mastercard®, American Express®, etc., as well as banking institutions, such as Chase®, Bank of America®, Wells Fargo®, etc.

The present disclosure is directly primarily, but not exclusively, to portable (mobile) devices that have NFC capabilities built in and which are also capable of receiving data from external sources. As one non-exclusive example, the disclosure is directed to a portable (mobile) device, such as, but not limited to, a mobile phone having NFC capability. The mobile phone may be a relatively simple device capable to handling audio communications over cellular telephone links, and also capable of receiving text messages via SMS. Alternatively, the portable (mobile) device may be a smartphone with multiple communication capabilities, including, but not limited to, cellular communications, internet (e.g., e-mail) capabilities, WiFi communication capabilities, Bluetooth or Bluetooth Low Energy (BLE) communication capabilities, satellite communication capabilities, and/or any other communication capabilities presently available.

Currently, it is not uncommon for mobile device users to pay for purchases using the NFC capabilities built in to their mobile device. At the point of sale, the user momentarily touches or taps their mobile device to a Point Of Sale (POS) terminal or ancillary device containing a NFC reader at a retailer's location. The momentary touch occurs for no more than one or a few seconds. Payment information, including the user's account information, and user ID and password information, if necessary, is transmitted from the mobile device to the POS terminal via the NFC communication link. Typically, this is a relatively small amount of information that can be transmitted in the short period of time that the mobile device is tapped to the POS terminal.

The act of making a purchase with a mobile device gives the retailer information about the purchaser's buying preferences. This provides the retailer with an opportunity to present advertising to the purchaser via the purchaser's mobile device. The retailer can send a coupon to the purchaser's mobile device for a discount toward a future purchase. For example, a grocery store can send a coupon to the purchaser's mobile device that is good for a free gallon of milk if the purchaser buys $15 worth of products from the grocery store on their next visit. Additionally or alternatively, the retailer can send targeted ads to the purchaser's mobile device based on their current purchase using their mobile device. The discount coupon or other advertising must be sent to the mobile device (e.g., smartphone) by the retailer.

The problem is that typically there is insufficient bandwidth between the POS terminal reader and mobile device tag to permit fast and efficient transfer of the relatively large amount of advertising data from the POS terminal to the mobile device. In order to receive the advertising information during the period of the NFC communication link between the mobile device and the POS terminal, the user would have to hold their mobile device next to the POS terminal for a relatively long period of time (on the order, for example, of between 15 seconds and several minutes) to enable the POS terminal to transmit the large amount of advertising data. This is generally unacceptable to the user. It is unlikely that a user would be willing to hold their mobile device in contact with the POS terminal for the time needed to transfer advertising content from the POS terminal to the mobile device via the NFC communication link.

One way to overcome this problem is to have the mobile device transmit to the POS terminal via the NFC tag and reader communication link a small amount of data in addition to the payment data. This small amount of data comprises information about other types of connectivity that are available on the mobile device, such as, but not limited to, WiFi, Bluetooth, low energy Bluetooth (BLE), internet (e.g., e-mail) access, SMS, etc. This data may also include information about what types of advertising content, if any, the user of the mobile device will allow to be sent to the mobile device. Based on the connectivity information and user selections received from the mobile device via the NFC link, the POS terminal (or the terminal infrastructure) can then determine which available connectivity protocol is best suited to transmit the desired advertising data from the retailer to the mobile device.

In another embodiment, the POS terminal may transmit to the mobile device information about the types of connectivity available at the POS terminal or the POS terminal infrastructure. The mobile device can then make a determination as to which of the connectivity protocol combinations available to both the mobile device and the POS terminal is best suited to pull relevant advertising content from the retailer to the mobile device. Again, the connectivity protocol information transmitted from the POS terminal to the mobile device is a small amount of data and can be transmitted during the “tap” period when the mobile device sends payment information to the POS terminal.

Using the alternate connectivity path, the retailer can send advertising information to the user's mobile device. This advertising information may include text and/or videos, depending on the communication capabilities of the mobile device and the retailer. This transmission can be accomplished at any convenient time. For example, if the retailer determines that a WiFi connection can be established between the retail establishment and the user's mobile device, the retailer can send the advertising over the WiFi connection. Alternatively, the retailer may determine that a Bluetooth connection can be established to enable the advertising to be transmitted over the Bluetooth connection.

One feature of this disclosure is that the mobile device transmits to the POS terminal information about other forms of connectivity that are available on the mobile device, including the configuration data for each of the additional forms of available connectivity, such as, but not limited to, the MAC address of a WiFi chip installed in the mobile device, the Bluetooth configuration of the mobile device, the e-mail address of the user, the phone number of the mobile device, etc. The information packet can also include information about whether the mobile device user has elected to receive only certain types of advertising content (e.g., text only or text and video) or has opted out of receiving this type of advertising information entirely. This data package can be sent from the mobile device to the POS terminal via the NFC link quickly as an adjunct to the payment information. The connectivity information comprises a relatively small package of data that is transmitted during the “tap” period. The user is thus not required to hold the mobile device against the POS terminal for a relatively long period of time that would otherwise be annoying or unacceptable to the user.

On the POS terminal side, once the communication protocol information has been received at the retailer (and more specifically, at the POS terminal) from the mobile device, a decision can then be made by the retailer as to which of the available additional connectivity mechanisms can or should be used to transmit the substantive advertising material to the mobile device. For example, if the retailer wants to send a video ad with a coupon attached to it, the retailer will want to use a high bandwidth transmission protocol, such as WiFi. If WiFi is not available, the retailer may elect to send the video via an internet connection to the user's e-mail address. If the advertising comprises only a text coupon for a free (or reduced price) product, the retailer may elect to use Bluetooth (if available) or an SMS text message.

The selection of a transmission mechanism depends on a number of factors, including, but not limited to, the transmission mechanisms available on the mobile device, the transmission mechanisms available to the retailer, the type and content of the advertising information to be transmitted, and user preferences. The selection of a transmission mechanism can be different for each mobile device user, depending on one or more of the foregoing factors. For example, a user with an unlimited data plan may elect to receive video advertising content via e-mail over an Internet connection. Another user may opt to receive video content only over a WiFi connection. One mobile device may have multiple forms of available connectivity, including high bandwidth WiFi, Bluetooth, SMS, etc. A device of this type is capable of receiving a video ad transmitted by the retailer over the most suitable of the available transmission protocols. A second mobile device may only have SMS capability. This device will receive only a text advertisement. Both mobile devices ultimately receive the same discount coupon sent by the retailer. The advertising that is transmitted may be customized for that particular mobile device.

In addition to payment information, the mobile device transmits to the POS terminal information about (a) the transmission protocols that the mobile device has available for receiving data, (b), the type of content the mobile device will accept, typically based on user specified values, and (c) whether the mobile device is willing to accept any advertising content at all. Alternatively, if the user is unwilling to accept any advertising content at all, the mobile device may not send any communication protocol information to the POS terminal. In a further embodiment, the user may send information specifically opting out of receiving any advertising content at all. The POS terminal or retailer can then transmit advertising content as a function of (a) the connectivity data transmitted by the mobile device over the NFC connection and received by the POS terminal, (b) the communication capabilities of the POS terminal or retailer, and (c) the user preference data transmitted by the mobile device to the POS terminal over the NFC connection.

The POS terminal may send the advertising information while the user (with the mobile device) is on the retailer's premises. Alternatively, the advertising information may be sent at a later time, particularly if the user's e-mail address or mobile number has been sent to the POS terminal. The POS terminal may also be only a conduit for transmitting the user's mobile device capabilities to a central data processing point, such as a data center at the retailer's main offices or other location remote from the POS terminal. Decisions about which transmission protocol to use and what type of advertising material to transmit can be made at such “back office” location remote from the POS terminal. If the POS terminal or retail establishment has WiFi and/or Bluetooth capability, the central office may instruct the POS terminal or retail establishment to transmit the advertising information to the user's mobile device via a WiFi or Bluetooth connection while the user is on the premises of the retail establishment.

Although the foregoing discussion has been primarily directed to sending connectivity data from the mobile device to the POS terminal, it will be apparent to anyone skilled in the relevant art that the transmission can proceed in the opposite direction. Specifically, the POS terminal can transmit connectivity protocol information to the mobile device. The mobile device can select the best combination of connectivity protocols based on the factors discussed above. The mobile device can then pull down advertising content from the retailer using the best combination of connectivity protocols (e.g., the “best fit”).

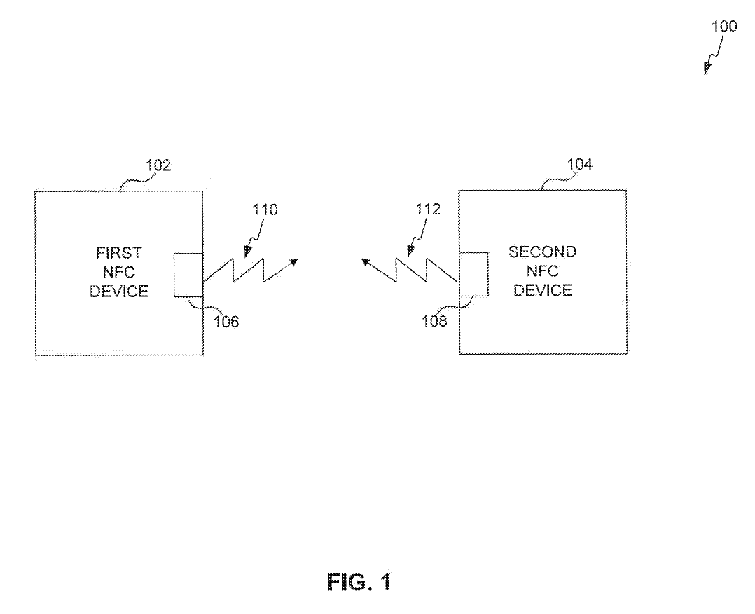

FIG. 1 illustrates a block diagram of a NFC environment 100 according to an exemplary embodiment. NFC environment 100 provides wireless communication of information among a first NFC device 102 and a second NFC device 104 that are closely proximate to each other (typically between 0 cm and 4 cm spacing). The information may include one or more commands to be executed by the first NFC device 102 and/or the second NFC device 104, data from one or more data storage devices that is to be transferred to the first NFC device 102 and/or the second NFC device 104, or any combination thereof. The data storage devices may include one or more contactless transponders, one or more contactless tags, one or more contactless smartcards, or any other machine-readable media that will be apparent to those skilled in the relevant art(s) without departing from the spirit and scope of the disclosure, or any combination thereof. The other machine-readable media may include, but are not limited to, read only memory (ROM), random access memory (RAM), magnetic disk storage media, optical storage media, flash memory devices, electrical, optical, acoustical or other forms of propagated signals such as carrier waves, infrared signals, digital signals to provide some examples.

NFC devices 102 and 104 may be any of three types of devices. One type is a tag, or target. A tag is passive. A tag contains data or executes commands. When brought into communication with another device, the tag transfers data and/or commands to the second device. As one example, a tag may be an ID card that permits access to a building when the data stored on the tag is read. A second type is a reader, or initiator. A reader generates an electromagnetic field which is modulated by a tag. An example of a reader may be the unit mounted on the building wall that reads the information stored in the tag. The reader reads data stored on the tag and may take action based on the received information. A controller is a device that incorporates features of both a tag and a reader. A controller typically has more “intelligence” than a tag. That is, a controller may handle more computational and operational functions than a tag. A controller may act as a tag, or a reader, or both. For purposes of the present disclosure, a tag, a reader, and a controller will be referred to herein individually and collectively as a “NFC device.”

The first NFC device 102 and/or the second NFC device 104 may be implemented as a standalone or a discrete device or may be incorporated within or coupled to larger electrical devices or host devices such as portable telephones, portable computing devices, other computing devices such as personal, laptop, tablet, or desktop computers, computer peripherals such as printers, portable audio and/or video players, television receivers, a payment system, ticket writing systems such as parking ticketing systems, bus ticketing systems, train ticketing systems or entrance ticketing systems to provide some examples, or in ticket reading systems, toys, games, posters, packaging, advertising materials, product inventory checking systems and/or any other suitable electronic device that will be apparent to those skilled in the relevant art(s) without departing from the spirit and scope of the disclosure.

The first NFC device 102 and/or the second NFC device 104 interact with each other to exchange information such as data and/or one or more commands to be executed by the first NFC device 102 and/or the second NFC device 104. Each NFC device 102 and 104 contains an antenna 106 and 108, respectively, to enable NFC devices 102 and 104 to communicate with each other. One example of such communications is a peer (P2P) communications mode or a reader/writer (R/W) communications mode. In the P2P communications mode, the first NFC device 102 and the second NFC device 104 may be configured to operate according to an active communications mode and/or a passive communications mode. The first NFC device 102 modulates first information onto a first carrier wave, referred to as a modulated data communication, and generates a first magnetic field by applying the modulated data communications to the first antenna 106 to provide a first data communications 110. The first NFC device 102 ceases to generate the first magnetic field after transferring the first information to the second NFC device 104 in the active communications mode via the second antenna 108. Alternatively, in the passive communications mode, the first NFC device 102 continues to apply the first carrier wave without the first information, referred to as an unmodulated data communication, to continue to provide the first data communications 110 once the first information has been transferred to the second NFC device 104.

In the P2P communication mode, the first NFC device 102 is sufficiently proximate to the second NFC device 104 that the first data communications 110 is inductively coupled onto the second antenna 108 of the second NFC device 104. The second NFC device 104 demodulates the first data communications 110 to recover the first information. The second NFC device 104 may respond to the first information by modulating second information onto a second carrier wave and generating a second magnetic field by applying this modulated data communications to the second antenna 108 to provide a second modulated data communications 112 in the active communications mode. Alternatively, the second NFC device 104 may respond to the first information by modulating the first carrier wave that is inductively coupled onto the second antenna 108 with the second information to provide the second modulated data communications 112 in the passive communications mode.

In the R/W communications mode, the first NFC device 102 is configured to operate in an initiator, or reader, mode and the second NFC device 102 is configured to operate in a target, or tag, mode. This example is not limiting. Those skilled in the relevant art(s) will recognize that the first NFC device 102 may be configured to operate in the tag mode and the second NFC device 104 may be configured to operate in the reader mode in accordance with the teachings herein without departing from the spirit and scope of the present disclosure. The first NFC device 102 modulates the first information onto the first carrier wave and generates the first magnetic field by applying the modulated data communications to the first antenna 106 to provide the first data communications 110. The first NFC device 102 continues to apply the first carrier wave without the first information to continue to provide the first data communications 110 once the first information has been transferred to the second NFC device 104. The first NFC device 102 is sufficiently proximate to the second NFC device 104 that the first data communications 110 is inductively coupled onto the second antenna 108 of the second NFC device 104.

The second NFC device 104 derives or harvests power from the first data communications 110 to recover, to process, and/or to provide a response to the first information. The second NFC device 104 demodulates the first data communications 110 to recover the first information. The second NFC device 104 processes the first information. The second NFC device 104 may respond to the first information by modulating the second information onto the second carrier wave and generating the second magnetic field by applying this modulated data communications to the second antenna 108 to provide the second modulated data communications 112.

Further operations of the first NFC device 102 and/or the second NFC device 104 may be described in International Standard ISO/IE 18092:2004(E), “Information Technology—Telecommunications and Information Exchange Between Systems—Near Field Communication—Interface and Protocol (NFCIP-1),” published on Apr. 1, 2004 and International Standard ISO/IE 21481:2005(E), “Information Technology—Telecommunications and Information Exchange Between Systems—Near Field Communication—Interface and Protocol—2 (NFCIP-2),” published on Jan. 15, 2005, each of which is incorporated by reference herein in its entirety.

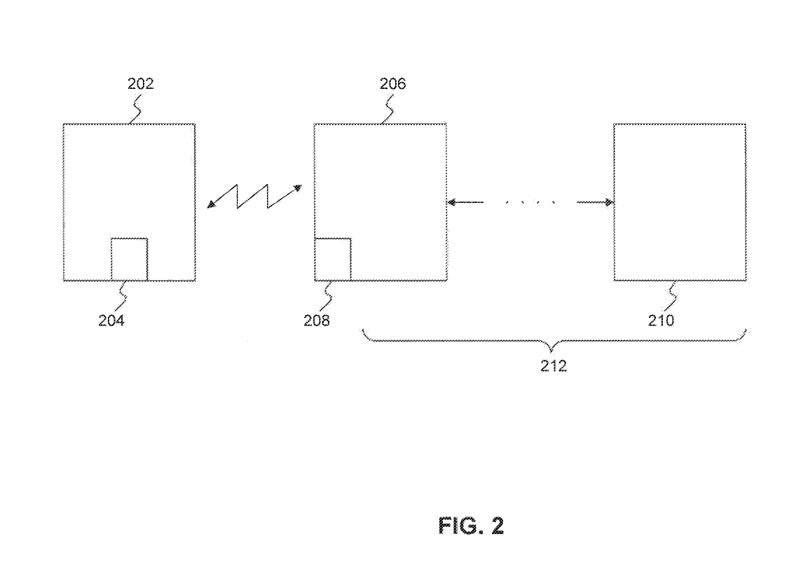

FIG. 2 is a block diagram of one embodiment of the present disclosure. In this embodiment, a mobile device 202 contains a NFC device 204. Typically NFC device 204 is configured to operate as a tag. A POS terminal 206 also contains a NFC device 208. Typically, NFC device 208 is configured to operate as a reader. HFC device 208 generates a magnetic field which is harvested by NFC device 204. NFC device 204 communicates payment information as well as information about the communication capability of mobile device 202 to NFC device 208 and POS terminal 206 when mobile device 202 is tapped to or brought near to or into contact with POS terminal 206.

POS terminal 206 may act on the communication capability of mobile device 202 itself or it may transmit this information to a remote location 210 of a retailer 212. Remote location 210 may be a central processing unit location in the retail establishment or it may be located at a separate facility. In any event, the information about the communication capability is processed by retailer 212 to determine the most appropriate communication protocol to use to send information to mobile device 202, as a function of the factors discussed above.

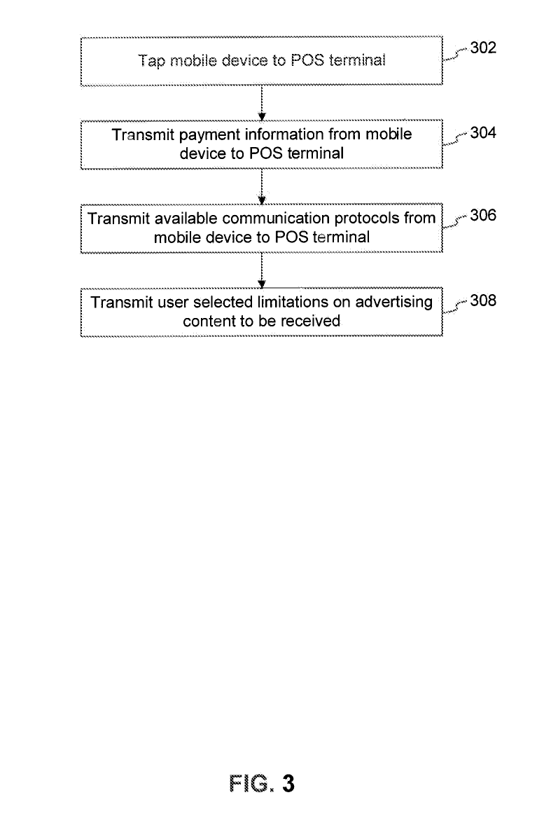

FIG. 3 is a flowchart of the process performed by mobile device 202 to transmit information to POS terminal 206. At step 302, mobile device 202 is “tapped” to POS terminal 206 to enable a NFC communication link to be established between the two devices. As used here, “tapped” encompasses actual touching of mobile device 202 with POS terminal 206 or bringing the respective NFC devices 204 and 208 into close proximity to each other sufficient to create a communication link. At step 304, payment information is transmitted via the NFC link from mobile device 202 to POS terminal 206. At step 306, a packet of information containing the communication protocols that are available at mobile device 202 are transmitted to POS terminal 206 via the NFC link. In addition, at step 308, user selected information, including, but not limited to, the type of information the user is willing to receive on mobile device 202 may also be transmitted as part of this information packet. In one embodiment, if the user has elected to opt out of receiving advertising information entirely, no information packet will be transmitted to POS terminal 206.

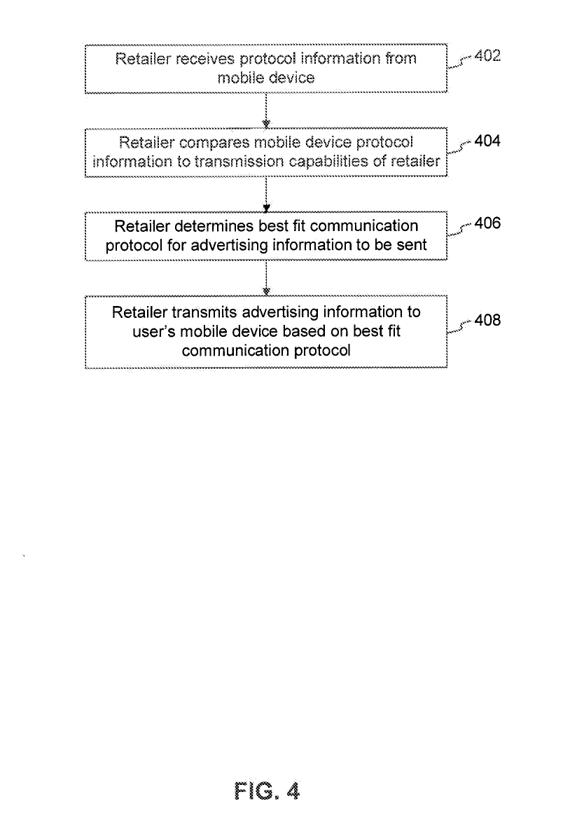

FIG. 4 is a flowchart of the process that takes place after POS terminal 206 has received communication protocol information from mobile device 202. At step 402, retailer 212 receives the communication protocol information from mobile device 202 via the NFC link with POS terminal 206. At step 404, retailer 212 compares the communication protocol information received from mobile device 202 with the transmission capabilities available to retailer 212. At step 406, retailer 212 determines which of the retailer's communication protocols constitutes a best fit match with the mobile device's available communication protocols for the advertising information to be sent to mobile device 202. At step 408, retailer 212 transmits the advertising information to mobile device 202 based on the best fit communication protocol determined by retailer 212. Typically, the best fit match will be one other than the NFC link.

As used here, a “best fit match” is intended to mean a selection of a communication protocol that is available on mobile device 202 in conjunction with a communication protocol that is available at retailer 212 which best meets the communication requirements necessary to deliver the desired information (e.g., advertising content, public service content, etc.) from retailer 212 to mobile device 202, in light of any restrictions or constraints placed on the communication by the user.

The above described embodiments refer to the use of advertising information transmitted from a retailer to a user's mobile device. It is contemplated that the information transmitted may take the form of public service announcements or any other form of information to be communicated from a central source to a mobile device once that central source has obtained information about the communication capabilities of the mobile device via a NFC tap communication connection.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

1. A method of processing signals in a wireless mobile device, comprising:
receiving at the wireless mobile device wireless signals associated with a plurality of geographic locations;
storing the received wireless signals in the wireless mobile device along with associated location information, the received wireless signals together with the associated location information collectively comprising reference location data; and
transmitting the reference location data to a location server from the wireless mobile device

2. The method according to claim 25, wherein at least one of the reference location data or the received GPRM comprises at least one reference position.

3. The method according to claim 1, further comprising: determining the reference location data from at least one of: surrounding base stations, WiFi towers, WiMAX towers, FM stations, or TV antennas.

4. The method according to claim 1, further comprising: determining the reference location data based on satellite data received by the wireless mobile device.

5. The method according to claim 25, wherein the reference location data comprises a location identifier that indicates a coverage area of the received GPRM.

6. The method according to claim 5, further comprising: generating, by the location server, the received GPRM based on the location identifier.

7. The method according to claim 25, wherein at least one of the reference location data or the received GPRM is Cell-ID based, RNC (Radio Network Controller) based, MNC (Mobile Network Code) based, or MCC (Mobile Country Code) based.

8. (canceled)

9. The method according to claim 25, further comprising: updating the reference location data stored within the wireless mobile device based on the received GPRM.

10. The method according to claim 25, further comprising: determining a position fix for the wireless mobile device based on at least one of Assisted Global Positioning System (AGPS) data, long term orbits (LTO) AGPS data, the reference location data, or the received GPRM.

11. (canceled)

12. A system for processing signals in a Global Positioning System (GPS) enabled wireless mobile device, comprising:
a GPS front end in the wireless mobile device; and
a processor for use in the wireless mobile device operatively coupled to the GPS circuit and configured to:
receive at the GPS front end a plurality of wireless signals associated with a plurality of geographic locations.
store the received wireless signals in the wireless mobile device along with associated location information, the received wireless signals together with the associated location information collectively comprising reference location data, and
transmit the reference location data to a location server.

13. The system according to claim 27, wherein at least one of the reference location data or the received GPRM comprises at least one reference position.

14. The system according to claim 12, wherein the processor is configured to determine the reference location data from at least one of: surrounding base stations, WiFi towers, WiMAX towers, FM stations, or TV antennas.

15. The system according to claim 12, wherein the processor is configured to determine the reference location data based on satellite data received by the GPS front end.

16. The system according to claim 27, wherein the reference location data comprises a location identifier that indicates a coverage area of the received GPRM.

17. The system according to claim 16, wherein the location server is configured to generate the received GPRM based on the location identifier.

18. The system according to claim 27, wherein said the reference location data or the received GPRM is Cell-ID based, RNC (Radio Network Controller) based, MNC (Mobile Network Code) based, or MCC (Mobile Country Code).

19. (canceled)

20. The system according to claim 27, wherein the processor is configured to update the reference location data stored within the wireless mobile device based on the received GPRM.

21. The system according to claim 27, wherein the processor is configured to determine a position fix for the wireless mobile device based on at least one of: Assisted Global Positioning System (AGPS) data, long term orbits (LTO) AGPS data, the reference location data, or said the received GPRM.

22. (canceled)

23. A method of processing signals in a wireless mobile device, comprising:
receiving at the wireless mobile device a plurality of wireless signals associated with a plurality of geographic locations;
storing the received wireless signals in the mobile device along with associated location information, the received wireless signals together with the associated location information collectively comprising reference location data;
updating, in the wireless mobile device, the reference location data based on additional information received from a plurality of locations associated with a plurality of different wireless communication technologies;
storing at least a portion of the updated reference location data in the wireless mobile device;
transmitting the updated reference location data by the wireless mobile device to a location server, and
receiving, by the wireless mobile device from the location server, a global position reference map (GPRM) determined based on the transmitted updated reference location data.

24. The method according to claim 1, further comprising: receiving, by the wireless mobile device from the location server, a global position reference map (GPRM) determined based on the transmitted reference location data.

25. The method according to claim 24, wherein the wireless mobile device is a Global Positioning System (GPS) enabled device, the method further comprising:
receiving at a GPS front end of the wireless mobile device the wireless signals; and
storing the received wireless signals and associated location information in a database in the wireless mobile device.

26. The system of claim 12, wherein the processor is further configured to receive from the location server a global position reference map (GPRM) determined based on the transmitted reference location data.

27. The system of claim 26, wherein the wireless mobile device is a Global Positioning System (GPS) enabled device, and the processor is further configured to:
receive at a GPS front end of the wireless mobile device the wireless signals; and
store the received wireless signals and associated location information in a database in the wireless mobile device.
